(19) United States
(12) Patent Application Publication
(10) Pub. No.: US 2026/0219233 A1
(43) Pub. Date: Jul. 30, 2026

(54) ABNORMALITY SENSING METHOD AND ABNORMALITY SENSING DEVICE

(71) Applicant: HITACHI HIGH-TECH CORPORATION, Minato-ku, Tokyo (JP)

(72) Inventors: Miu IIZUKA, Tokyo (JP); Yuuki SAKURAI, Tokyo (JP); Motohiro YAMAZAKI, Tokyo (JP); Taro NAKAZAWA, Tokyo (JP)

(21) Appl. No.: 19/158,221

(22) PCT Filed: May 26, 2023
(86) PCT No.: PCT/JP2023/019714

§ 371 Date: Aug. 20, 2025

(51) Int. Cl. G01N 27/447

(52) U.S. Cl. CPC G01N 27/447

(57) ABSTRACT

With a view to accurately sensing the abnormality of an abnormality monitored device, an abnormality sensing device that reads a first current value from a first current meter connected, between a physical path through which a voltage applied by a power source flows and the voltage source, in series with the physical path and the voltage source carries out a step (S103) for calculating a standard deviation of a first current value and a step (S104) for outputting occurrence of discharge at an insulated portion, which is a path other than the physical path, when the standard deviation is greater than a first threshold value which is a predetermined threshold value.

### TECHNICAL FIELD

The present invention relates to the technology of an abnormality sensing method and an abnormality sensing device.

### BACKGROUND ART

There is a capillary electrophoresis apparatus that electrophoreses a sample (test specimen) in a capillary (capillary tube) filled with a polymer (migration separation medium) and thereby analyze the chemical properties of the sample. As one example of such the capillary electrophoresis apparatus, there is one configured to be able to sense a current that flows between an electrode in a cathode-side buffer solution and a high-voltage power source and a current that flows between an electrode in an anode-side buffer solution and GND. As another example, the capillary electrophoresis apparatus that can stop electrophoresis based on the variation in a current that flows between an electrode in an anode-side buffer solution and GND is commonly known.

For example, Patent Literature 1 discloses the electrophoresis apparatus and an electrophoresis method “that measure a current flowing into a current path during electrophoresis, sense the state of a separation medium, and stop application of a voltage to the current path, preferably sense the presence or absence of air bubbles in the separation medium based on a change in current value with time and stops application of a voltage to the current path when air bubbles are generated (refer to the abstract).

Patent Literature 2 discloses the capillary electrophoresis apparatus “which is an electrophoresis apparatus that has a capillary 02 and analyzes a sample by electrophoresis and is equipped with a heater assembly 60 for heating the capillary which assembly is equipped with a heater 62 serving as a heat source and a conduction member 63 having at least a portion made of a metal, wherein the conduction member 63 is brought into contact with a grounding site and at the same time, has been subjected to insulation treatment” (refer to the abstract).

### CITATION LIST

### Patent Literature

Patent Literature 1: Japanese Unexamined Patent Application Publication No. 2003-344356

Patent Literature 2: Japanese Unexamined Patent Application Publication No. 2020-38233

### SUMMARY OF INVENTION

### Technical Problem

Patent Literature 1 describes a method of sensing air bubbles based on a change in the value of a current that flows between an electrode in an anode-side buffer solution and GND and sensed by a second current meter.

The technology described in Patent Literature 1 has however a constitution that senses the presence or absence of air bubbles and the like based on a temporal change in current value sensed by the second current meter. This means that the technology described in Patent Literature 1 has a constitution capable of sensing the discharge or conduction failure due to air bubbles and the like generated in a flow path. The technology described in Patent Literature 1 however needs an improvement in the sensing of discharge generated outside the flow path. When Patent Literature 1 was written, the voltage applied to a flow path in the capillary electrophoresis apparatus was suppressed low within a predetermined range and each unit of the capillary electrophoresis apparatus was larger than it is now. The discharge occurring risk outside the flow path was markedly small at the time when Patent Literature 1 was written.

An air bubble sensing method described in Patent Literature 1 therefore functioned sufficiently and effectively as a countermeasure against discharge (electric leakage). In recent years, however, the situation around the capillary electrophoresis apparatus is changing. More concretely, the present inventors have found by ourselves that in the context that there is a growing demand for the increase in a voltage to be applied to a flow path or for the reduction in the size of the capillary electrophoresis apparatus, only the countermeasure against electric leakage in the flow path is not sufficient.

Countermeasures against growing tendencies to increase in a voltage to be applied to a flow path or to downsize the electrophoresis apparatus have become necessary. The increase in voltage to be applied to the flow path or downsizing of the capillary electrophoresis apparatus is generally presumed to accelerate the ease of discharging. Occurrence of discharge in the capillary electrophoresis apparatus is not preferred because it increases the likelihood of causing poor electrophoresis results.

Consideration of the countermeasure against discharge in the capillary electrophoresis apparatus has revealed that the countermeasure against discharge can be classified roughly into the following two methods. One of them is to improve the capillary electrophoresis apparatus into that having a constitution that does not cause discharge itself or does not easily cause it. The other one is to regard the device as that may cause discharge. In this case, when discharge occurs, it is sensed accurately and the capillary electrophoresis apparatus is stopped safely to minimize the influence of the discharge on the capillary electrophoresis apparatus.

The example described in Patent Literature 2 may be a former one. Patent Literature 2 discloses the capillary electrophoresis apparatus that does not cause discharge easily. Patent Literature 2 however does not include a constitution that when discharge occurs, senses it and stops the capillary electrophoresis apparatus based on the sensing results. This is because the technology described in Patent Literature 2 assumes that discharge basically does not occur or extremely small discharge having almost no influence on the safety of the device occurs very rarely. The constitution described in Patent Literature 2 is presumed to be able to take a sufficient countermeasure against discharge when the voltage to be applied to the flow path is suppressed low within a predetermined range or the capillary electrophoresis apparatus is large enough not to cause discharge.

As described above, however, in recent years, the situations around the capillary electrophoresis apparatuses have changed and there is a growing tendency to increase a voltage to be applied to a flow path or to downsize the capillary electrophoresis apparatus. With that in mind, it is necessary to take a safety countermeasure while supposing the occurrence of unexpected discharge outside the flow path due to an extremely high applied voltage or approximation between parts caused by downsizing of the capillary electrophoresis apparatus. Only improvement in the capillary electrophoresis apparatus itself into a constitution that is sufficiently hard to cause discharge is therefore insufficient and further improvement is necessary. Under such a situation, it is not preferred to depend only on the constitution that does not cause discharge itself as described in Patent Literature 2, or that is extremely hard to cause discharge. It is therefore necessary to load the constitution that senses the occurrence of discharge or the like accurately and stops the capillary electrophoresis apparatus safely.

Based on such a background, the present invention has been completed and an object of the present invention is to sense the abnormality of an abnormality monitored device accurately.

### Solution to Problem

With a view to overcoming the aforesaid problem, the present invention is characterized in that an abnormality sensing device that reads a first current value from a first current meter connected, between a first path through which a voltage applied by a voltage source flows and the voltage source, in series with the first path and the voltage source carries out: a standard deviation calculation step for calculating a standard deviation of the first current value; and a first determination step for outputting the occurrence of discharge in a second path which is a path other than the first path and at the same time is an insulated portion when the standard deviation is greater than a first threshold value which is a predetermined threshold value. The first path is provided in an abnormality monitored device that is a capillary electrophoresis apparatus, the first current meter is connected to a load header, and the second path is between the load header and a cathode buffer container or between the load header and a buffer solution contained in the cathode buffer container.

Other resolutions will be described in the following embodiments as needed.

### Advantageous Effects of Invention

According to the present invention, the abnormality of the abnormality monitored device can be sensed accurately.

### BRIEF DESCRIPTION OF DRAWINGS

FIG. 1 is a schematic view of a general abnormality sensing system to which an abnormality sensing method is to be applied.

FIG. 2 is a functional block diagram showing the constitution example of a processing device.

FIG. 3A is a view showing a temporal change in applied voltage and source current value under the state where no discharge is occurring at an insulated portion.

FIG. 3B is a view showing a temporal change in applied voltage and source current value under the state where discharge is occurring at an insulated portion.

FIG. 3C is a partially enlarged view of the view showing a temporal change in applied voltage and source current value under the state where discharge is occurring at an insulated portion.

FIG. 4 is a view showing a method for acquiring a source current value.

FIG. 5 is a flowchart showing an example of processing procedures according to a first embodiment.

FIG. 6 is a flowchart showing an example of processing procedures according to a fourth embodiment.

FIG. 7A is a device constitution diagram showing one example of a capillary electrophoresis system to be used in a seventh embodiment.

FIG. 7B is an enlarged view of an end portion of a hollow electrode.

FIG. 8 is a view showing a voltage control circuit for carrying out voltage control of a capillary electrophoresis apparatus.

FIG. 9 is a flowchart showing one example of processing procedures from the start to the end of analysis using the capillary electrophoresis apparatus.

FIG. 10 is a flowchart showing one example of processing procedures of checking a current value according to the seventh embodiment.

FIG. 11 is a flowchart showing an example of processing procedures according to an eighth embodiment.

FIG. 12 is a flowchart showing an example of processing procedures according to a ninth embodiment.

FIG. 13 is a flowchart showing an example of processing procedures according to a tenth embodiment.

FIG. 14 is a flowchart showing an example of processing procedures according to an eleventh embodiment.

FIG. 15 is a flowchart showing an example of processing procedures according to a twelfth embodiment.

FIG. 16 is a flowchart showing an example of processing procedures according to a thirteenth embodiment.

FIG. 17 is a view showing one example of an abnormality sensing screen.

### DESCRIPTION OF EMBODIMENTS

The abnormality sensing method of the present invention will hereinafter be described in detail by each embodiment while referring to the drawings.

### First Embodiment

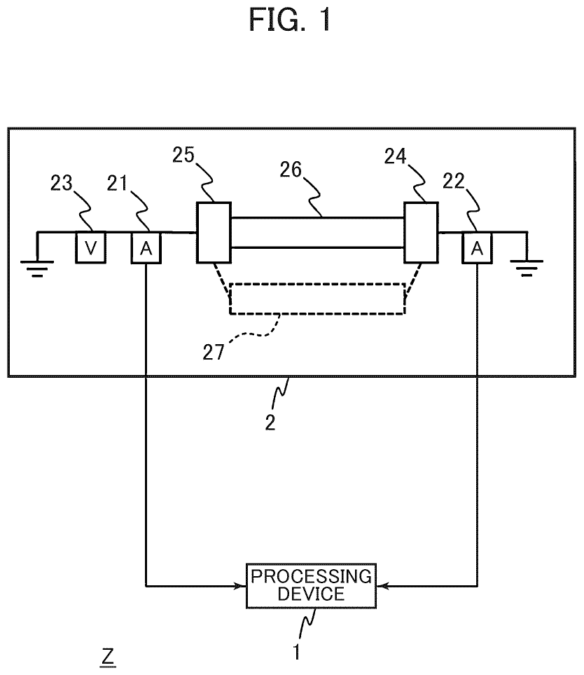

First, the outline of the first embodiment will be described referring to FIGS. 1 to 5.

### Summary of Abnormality Sensing System Z

FIG. 1 is a schematic view of a general abnormality sensing system Z to which the abnormality sensing method is to be applied in the first embodiment. FIG. 1 shows an abnormality monitored device 2 to which a processing device 1, which is an abnormality sensing device for sensing the abnormality of the abnormality monitored device 2 is connected.

The abnormality monitored device 2 has a physical path 26 which is a first path. In addition, the abnormality monitored device 2 has a positive electrode terminal 25 to which a positive voltage is applied and a negative electrode terminal 24 to which a negative voltage is applied. A voltage source 23 is connected to either one of the positive electrode terminal 25 and the negative electrode terminal 24. the voltage source 23 is a DC voltage source. In the example shown in FIG. 1, the voltage source 23 is connected to the positive electrode terminal 25. The voltage source 23 applies a voltage to the positive electrode terminal 25 or negative electrode terminal 24. In the example shown in FIG. 1, the voltage source 23 is connected to the positive electrode terminal 25. A source current is a current observed at a source current meter 21 which is a first current meter directly connected to the voltage source 23. A current observed by a return current meter 22 which is a second current meter connected to the voltage source 23 via the physical path 26 through which a voltage applied by the voltage source 23 flows is called “return current”. It is to be noted that the voltage source 23 is grounded and at the same time, is also grounded on a side (on the side of the return current meter 22) opposite to the connected side of the voltage source 23.

The processing device 1 senses abnormality at the physical path 26 and at an insulated portion 27 which is a second path, a path other than the physical path 26. In the present embodiment, the term “physical path 26″ means a portion where an electric current flows when the voltage source 23 applies a voltage. The term ”insulated portion 27″ means a portion other than the physical path 26 and particularly a portion where discharge occurs, as will be described later. The physical path 26 is formed between the positive electrode terminal 25 and the negative electrode terminal 24. The insulated portion 27 is a portion which is other than the physical path 26 thereof and may be influenced by an applied voltage.

As shown in FIG. 1, the source current meter 21 is connected in series with the physical path 26 and the voltage source 23 between the physical path 26 and the voltage source 23. The return current meter 22 is, on the other hand, connected in series with the physical path 26 and the voltage source 23 on the side opposite to the voltage source 23 via the physical path 26.

It is to be noted that the voltage source 23 and the return current meter 22 are grounded to make the voltage source 23 and the return current meter 22 equal in potential.

In first to third embodiments, the return current meter 22 may be omitted.

### Processing Device 1

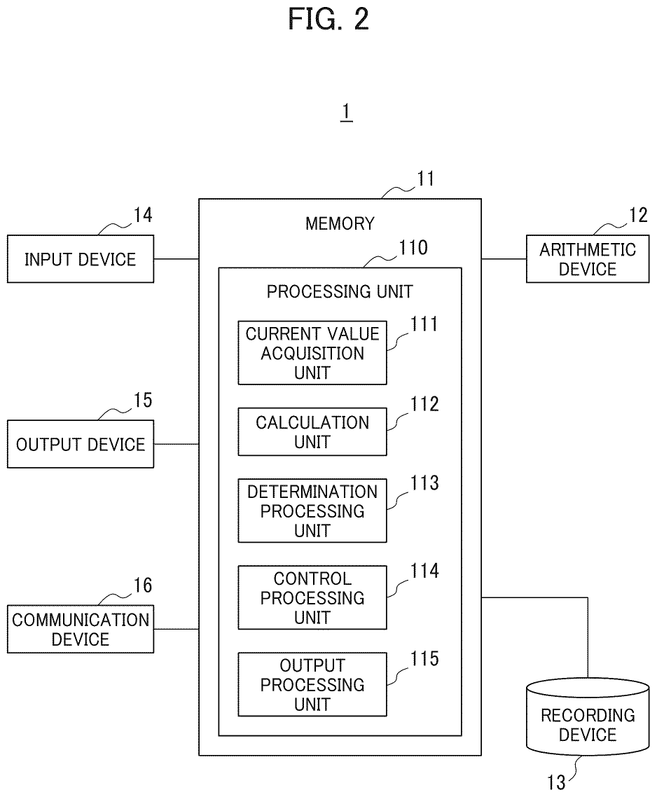

FIG. 2 is a functional block diagram showing the constitution example of the processing device 1. FIG. 1 is referenced as needed.

The processing device 1 is PC or the like and is equipped with a memory 11 constituted of RAM or the like, an arithmetic device 12 constituted of CPU, GPU, or the like, and a recording device 13 constituted of HD, SSD, or the like. In addition, the processing device 1 is equipped with an input device 14 such as keyboard, mouse, or the like, an output device 15 which is an output unit, and a communication device 16 for giving and receiving information with the abnormality monitored device 2.

A program stored in the recording device 13 is loaded on the memory 11 and executed by the arithmetic device 12. This realizes a processing unit 110 and a current value acquisition unit 111, a calculation unit 112, a determination processing unit 113, a control processing unit 114, and an output processing unit 115 that constitute the processing unit 110.

The current value acquisition unit 111 acquires a source current value which is a first current value and a return current value which is a second current value from the source current meter 21 or the return current meter 22 via the communication device 16.

The calculation unit 112 calculates the standard deviation of the source current value or the variation value of the return current value.

The determination processing unit 113 determines whether or not abnormality is occurring at the insulated portion 27 or physical path 26 based on the standard deviation of the source current value or the variation value of the return current value.

The control processing unit 114 carries out stopping or the like of the abnormality monitored device 2 or the like according to the determination results of the determination processing unit 113.

The output processing unit 115 carries out output of an error, an alert, or the like to the output device 15 according to the determination results of the determination processing unit 113.

It is to be noted that the control processing unit 114 is used in the fifth embodiment, the eighth embodiment, and the twelfth embodiment. It is to be noted that the output processing unit 115 is used in a second embodiment, the third embodiment, a sixth embodiment, a ninth embodiment, an eleventh embodiment, and a thirteenth embodiment.

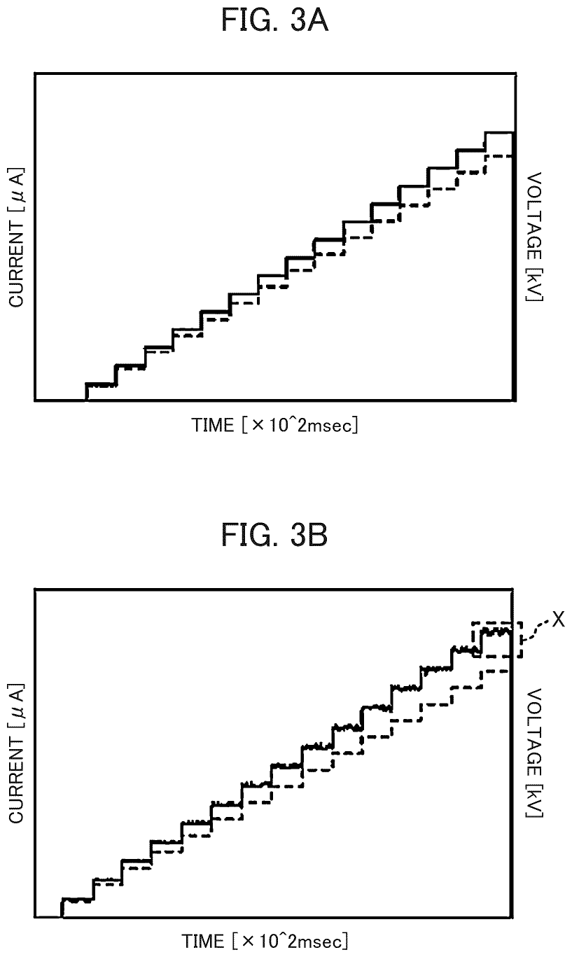

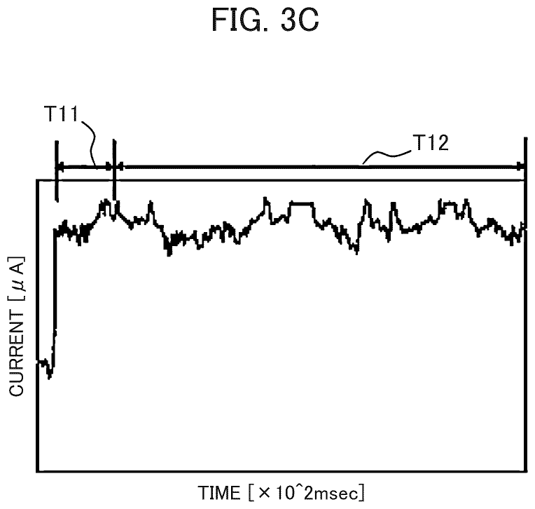

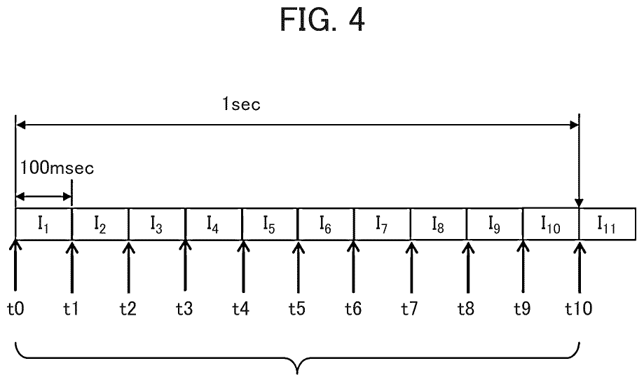

The present inventors have found by themselves that the abnormality which will cause current variation not only occurs at the physical path 26 but also occurs as discharge at the insulated portion 27. A method of observing the discharge which occurs at the insulated portion 27 will hereinafter be described using FIGS. 3A to 3C.

### Temporal Change in Source Current

FIG. 3A is a view showing a temporal change in applied voltage and source current value under the state where no discharge is occurring at the insulated portion 27. FIG. 3B is a view showing a temporal change in applied voltage and source current value under the state where discharge is occurring at the insulated portion 27. FIG. 3C is an enlarged view of a portion indicated by the code “X” of FIG. 3B.

In FIGS. 3A to 3C, a source current value (unit: μA), an applied voltage value (voltage) (unit: KV), and an elapsed time (time) (unit: 102 msec) for voltage application are plotted along a first ordinate, a second ordinate, and an abscissa, respectively. It is to be noted that in FIGS. 3A to 3C, a solid line indicates a source current value and a broken line indicates an applied voltage. In FIGS. 3A to 3C, the voltage is applied in staircase fashion. This is because the voltage is applied in a staircase fashion for the purpose of an experiment, the voltage is actually applied in one stage. In FIGS. 3A to 3C, since the voltage is applied in staircase fashion, the source current also changes in staircase fashion.

The comparison between the graphs shown in FIGS. 3A and 3B has revealed the following. First, FIG. 3A shows that when no discharge is occurring at the insulated portion 27, the source current value appears as a flat curve. This suggests that the source current value is stable. This is because no current leaks outside (leaks to the insulated portion 27) and the source current value is stable. On the other hand, as shown in FIGS. 3B and 3C, when discharge is occurring at the insulated portion 27, the source current value appears as a curve that shifts while rising and falling finely. This suggests that the source current value is in disorder. This is because the source current value is not stable due to generation of discharge outside the physical path 26 (that is, at the insulated portion 27) and leakage of the source current value.

The present embodiment is characterized by that the discharge generated at the insulated portion 27 is sensed based on the behavior of the source current value by making use of the characteristics of the source current value as shown in FIGS. 3A to 3C. The specific embodiment of the abnormality sensing method of the present embodiment will be described later referring to FIG. 4. It can be understood from FIGS. 3A to 3C that the source current value shows an almost vertical increase immediately after an increase in an applied voltage. This is an ordinary phenomenon that occurs according to Ohm's law and at the same resistance value, the source current increases with an increase in the applied voltage. This increasing variation of the source current value therefore is not due to abnormality of discharge. The present inventors have found by themselves that to discriminate the variation of the source current value caused by the abnormality of discharge at the insulated portion 27 from another variation of the source current value therefore becomes one of the objects. In the present embodiment, therefore, as shown in FIG. 3C, the source current value in a predetermined term (term T11) immediately after the applied voltage shows a large variation almost vertically is excluded from the basis of discharge sensing. One of the characteristics of the abnormality sensing method of the present embodiment is that the discharge is sensed based on the source current value other than the source current value in the term (term T12) other than the excluded term. A change in the source current value that has appeared immediately after voltage variation may be a change caused by a change in voltage.

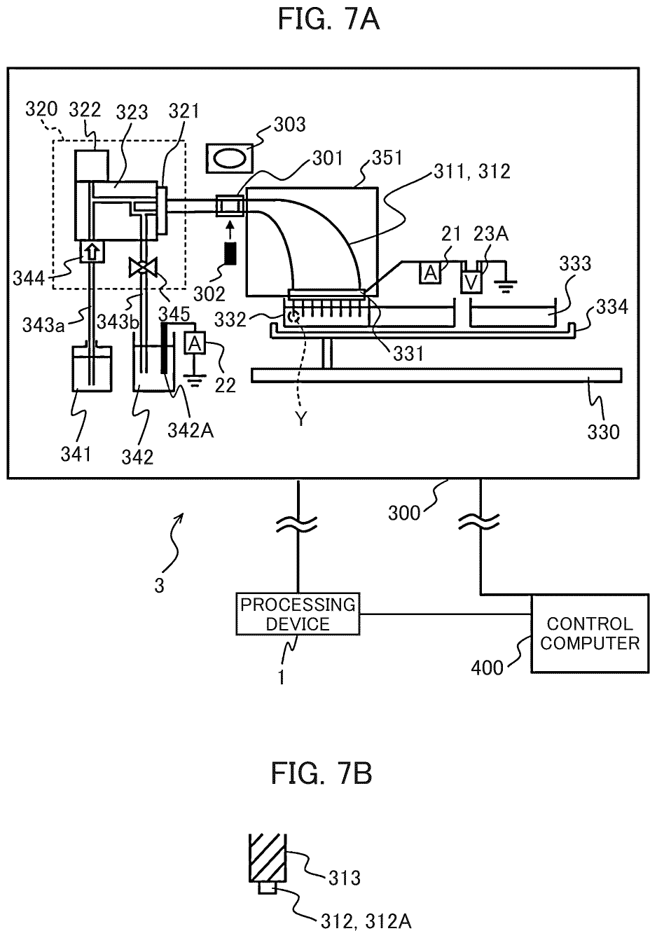

The change in voltage is performed by the instruction of an operator or by the instruction of a control computer 400 (refer to FIG. 7A) that controls the voltage source 23. The processing device 1 can however accept the instruction from the control computer 400 and thereby sense the timing of the change in voltage. It is however impossible to discriminate whether or not the variation of the source current value to be measured is caused by a change in voltage, because as will be described later, the variation of the source current value includes that caused by the discharge at the insulated portion 27. In the present embodiment, therefore, the source current value immediately after a voltage change is excluded from discharge determination.

FIG. 4 is a view showing a method for acquiring the source current value.

In the present embodiment, using the standard deviation of the source current value makes it possible to differentiate and specify the fine vertical variation of the source current value caused by the discharge at the insulated portion 27 from the variation that follows Ohm's rule. The variation that follows Ohm's rule is a variation caused by a change in voltage by the control computer 400 (refer to FIG. 7A). For example, as shown in FIG. 3, ten source current values are sampled per second by measuring the source current value per 100 msec (measured time: “t0” to “t10”). This means that the source current value is measured (sampled) at a sampling cycle of 100 msec in a sampling term of 1 sec. The processing device 1 then calculates a standard deviation based on the ten source current values acquired by measurement for one second. Compared with the case where no discharge is occurring at the insulated portion 27, the standard deviation of the source current value becomes larger because the source current value varies when the discharge is occurring at the insulated portion 27. It is to be noted that the sampling term of the source current value is not limited to 1 sec and the sampling cycle of the source current value is not limited to 100 msec. In addition, the sampling frequency is not limited to 10 times as shown in FIG. 3.

In the present embodiment, therefore, a first threshold value is set as a certain threshold value, and when the standard deviation value of the source current value exceeds the first threshold value, the source current value is determined to be abnormal. A user determines the first threshold value in consideration of a parameter having an influence on the source current value.

### Flowchart

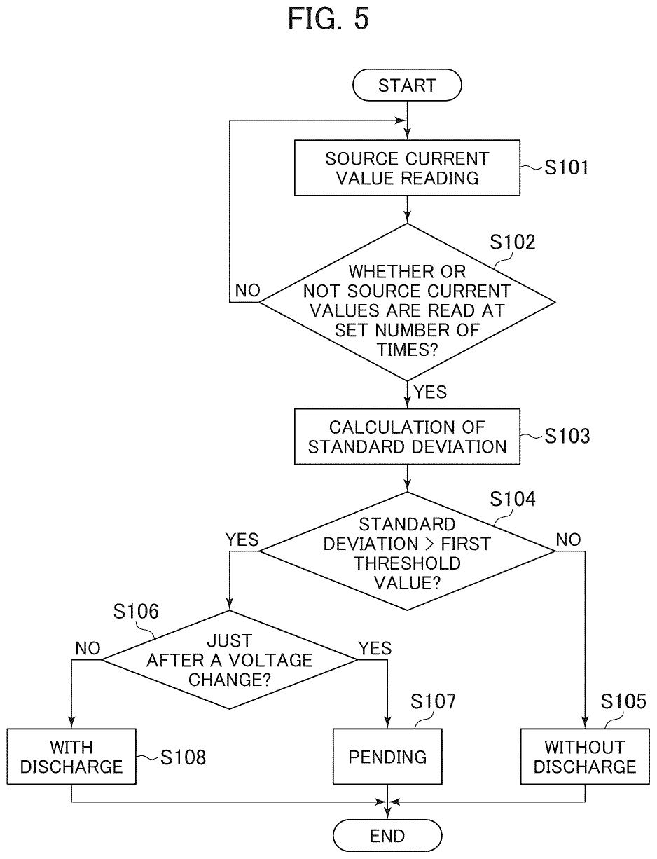

Next, the abnormality sensing method shown in the first embodiment will next be described referring to the flowchart of FIG. 5.

FIG. 5 is a flowchart showing an example of processing procedures according to the first embodiment. FIG. 1 is referenced as needed.

The flowchart shown in FIG. 5 includes the processing performed whenever source current values are read by the source current meter 21.

The current value acquisition unit 111 reads source current values from the source current meter 21 (S101). The source current values are read by a sampling method as shown in FIG. 4.

In short, the source current values are read at the timing of the time t0 to t10 shown in FIG. 4. Step S101 is a source current value reading step in which the current value acquisition unit 111 reads source current values at a predetermined sampling cycle (at a predetermined interval of time).

The calculation unit 112 determines whether or not the source current values are read at a set number of times (set number of times: 10 times in an example shown in FIG. 4).

When the source current values are not read at a set number of times (S102→No), the processing device 1 returns the processing to Step S101.

When the source current values are read at the set number of times (S102→Yes), the calculation unit 112 uses each of the source current values thus read to calculate the standard deviation of the source current values (S103). Step S103 is a standard deviation calculation step. This means that in Step S103, the calculation unit 112 calculates a standard deviation based on the source current values read at predetermined time intervals.

The determination processing unit 113 then determines whether or not the standard deviation calculated in Step S103 is greater than the first threshold value (S104: first determination step).

When the standard deviation value is not more than the first threshold value (S104→No), the determination processing unit 113 determines that discharge is not occurring (without discharge) at the insulated portion 27 (S105).

When the standard deviation value is greater than the first threshold value (S104→Yes), the determination processing unit 113 determines whether or not the present current value is that immediately after a change in applied voltage (S106). The determination in Step S106 is performed by the determination processing unit 113 which determines whether or not a predetermined time has passed after a change in applied voltage.

As described above, immediately after a change in applied voltage, the source current value changes with a change in applied voltage according to Ohm's rule. When the determination is “Yes” in Step S106, the determination processing unit 113 determines that a change in the source current value is not caused by the discharge at the insulated portion 27 and pends the determination (S107→Exclusion step). Thus, an exclusion step is performed in which the source current value read within a predetermined time after a change in the voltage applied by the voltage source 23 is excluded from the discharge determination object.

As to exclusion of a source current value that has passed a certain term since a change in applied voltage, it is possible to set different value for the term, depending on the condition of the abnormality monitored device 2. The first threshold value used in Step S104 is a predetermined threshold value which can be set by an operator and for example, σ, 2σ (σ is a standard deviation), or the like can be set.

On the other hand, when the source current value read in Step S106 is not a value immediately after a change in applied voltage (S106→No), the determination processing unit 113 determines that discharge is occurring at the insulated portion 27. In this case, as described later, the control processing unit 114 may stop the abnormality monitored device 2 or the output processing unit 115 may output an error or alert to the output device 15.

In the first embodiment, even when the standard deviation of the source current value is greater than the first threshold value which is a predetermined threshold value, the processing device 1 excludes the source current value from the basis of abnormality determination when the current value is that immediately after a change in applied voltage. When the standard deviation of the sampled source current value other than the excluded source current value is smaller than the first threshold value, the processing device 1 determines “without discharge”. When discharge has occurred at the physical path 26, it can be sensed precisely. This makes it possible to selectively and precisely extract the variation in source current value involved the discharge at the insulated portion 27.

In the first embodiment, when the standard deviation of the source current value is greater than the first threshold value, the determination is that discharge is occurring. This makes it possible to stop the abnormality monitored device 2 safely as will be described later in the second embodiment, or precisely transmit the abnormality to an operator of the abnormality monitored device 2 as will be described later in the third embodiment.

It is to be noted that the processing in Step S104 and that in Step S106 may be interchanged with each other.

### Second Embodiment

What is described above In the first embodiment is the abnormality sensing method for checking whether or not discharge is occurring at the insulated portion 27. In the second embodiment, on the other hand, when discharge is occurring at the insulated portion 27, the output processing unit 115 outputs an error or the like.

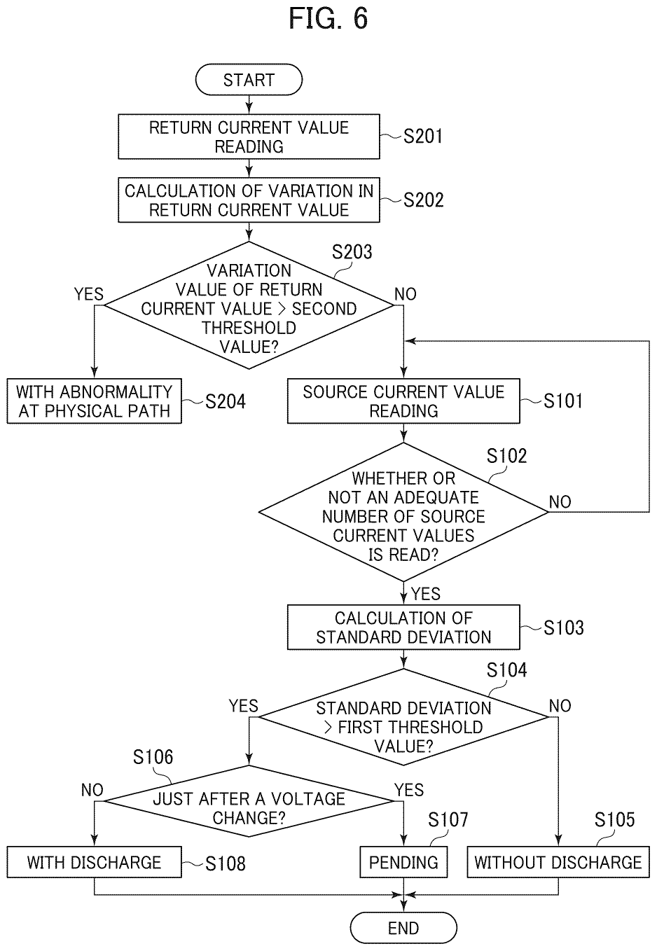

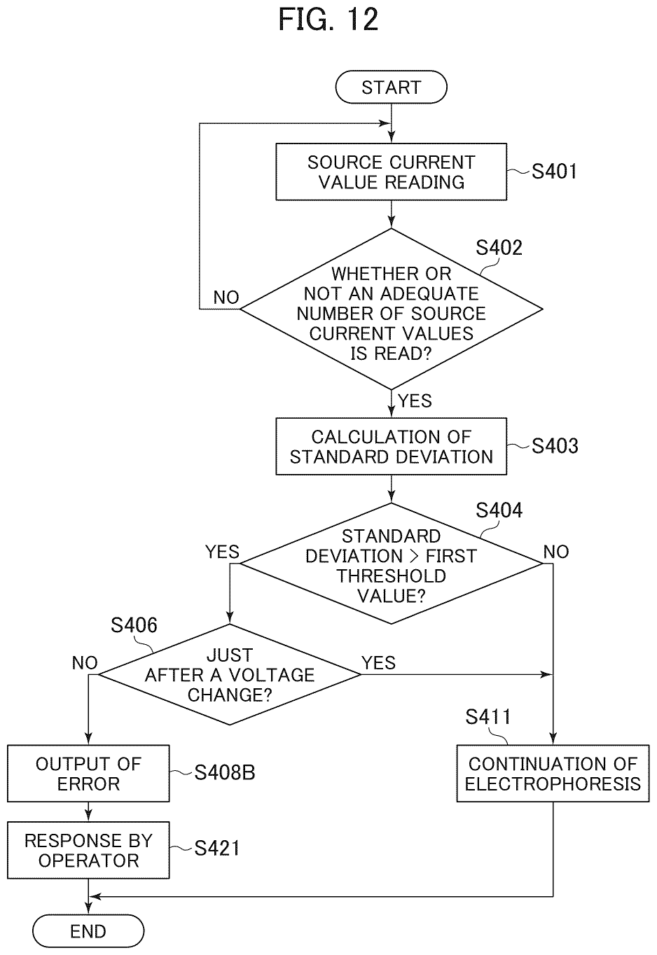

Although not shown, immediately after the determination processing unit 113 determines that the insulated portion is “with discharge” in Step S108 in FIG. 6 of the first embodiment, it outputs an error and adds processing to forcibly stop the abnormality monitored device 2. The second embodiment is different from the first embodiment in this respect but, in other respects, processing common to that of the first embodiment is performed. In the second embodiment, when it is determined that discharge is occurring at the insulated portion 27, the abnormality monitored device 2 is forcibly stopped. This makes it possible to prevent parts of the abnormality monitored device 2 from being damaged because the operator does not move the abnormality monitored device 2 when the discharge is occurring at the insulated portion 27. The processing to be performed in the second embodiment is similar to that shown later in FIG. 12.

### Third Embodiment

What is described above In the first embodiment is the abnormality sensing method for checking whether or not discharge is occurring at the insulated portion 27. In the third embodiment, an alert is output as one specific example of error output. Although not shown, the output processing unit 115 carries out an alert output processing when it determines that the insulated portion is “with discharge” in Step S108 of FIG. 5 in the first embodiment. The third embodiment is different from the first embodiment in this respect, but the third embodiment and the first embodiment are common to each other in other respects. It is to be noted that in the processing in the third embodiment, Step S408B described later in FIG. 12 is replaced by the output of an alert. The output of an alert may be either sounding by a buzzer not shown or indication of an alert on the output device 15.

According to the third embodiment, as one specific example of the error output, when the output processing unit 115 outputs an alert, the operator can find the state of the abnormality monitored device 2 that discharge is occurring at the insulated portion 27.

### Fourth Embodiment

FIG. 6 is a flowchart showing an example of processing procedures according to the fourth embodiment. FIG. 1 is referenced as needed.

What is described above in the first embodiment is an abnormality sensing system Z that can ensure the sensing of discharge which is occurring at the insulated portion 27 by measuring the source current value. The fourth embodiment, on the other hand, has Steps S201 to S204, that is, steps of abnormality sensing processing of a return current value.

The source current is almost not influenced by the state of the physical path 26. As the source current, therefore, a current value introduced from an applied voltage and Ohm's rule appears almost as is. The return current is, on the other hand, influenced largely by the state of the physical path 26. This means that when some abnormality is found in the physical path 26 and discharge or conduction failure occurs due to this abnormality, the return current is influenced by the abnormality. By making use of the above-described property, in the fourth embodiment, the abnormality of the physical path 26 is sensed by observing the return current.

More specifically, a return current value is read by the return current meter 22 (S201: second current value reading step). Then, the calculation unit 112 calculates a variation value of the return current value (S202). More specifically, the determination processing unit 113 calculates a difference between the returned current value previously read and the return current value read this time.

The determination processing unit 113 then determines whether or not the variation value of the return current value is greater than the second threshold value (S203: second determination step).

When the variation value of the return current value is greater than the second threshold value (S203→Yes), the determination processing unit 113 determines that an abnormality is occurring at the physical path 26 (S204: second determination step). When the abnormality monitored device 2 is a capillary electrophoresis apparatus 300 as shown in FIG. 7A, the term “abnormality” means occurrence of air bubbles in the capillary 312 and further means occurrence of discharge or conduction failure in the capillary 312.

When the variation value of the return current value is not greater than the second threshold value (S203→Yes), the source current value is read by the source current meter 21 (S101). The processing after Step S101 is similar to that shown in FIG. 5.

The fourth embodiment is different from the first embodiment in the respect that it has Steps S201 to S204 which are abnormality sensing processing steps of the return current value but the fourth embodiment is common to First Embodiment in other respects. The fourth embodiment can sense the occurrence of abnormality in the physical path 26 because it has additional Steps S201 to 204 to sense the abnormality of the return current value. By indicating the abnormality sensing by the return current value and the discharge sensing by the source current value, it becomes easy for an operator to specify the place where abnormality is occurring.

### Fifth Embodiment

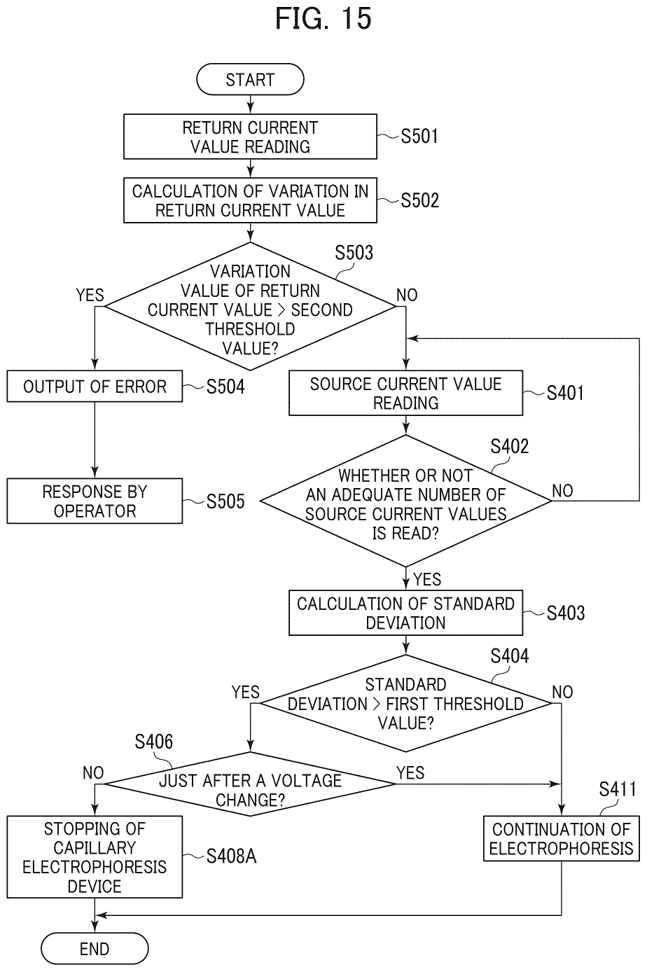

What is described above in the fourth embodiment is a sensing method for checking whether or not abnormality is occurring at the physical path 26 shown in FIG. 1. In the fifth embodiment, on the other hand, when discharge is occurring at the insulated portion 27, the control processing unit 114 (refer to FIG. 2) carries out processing for forcibly stopping the abnormality monitored device 2. Although not shown, processing for forcibly stopping the abnormality monitored device 2 is added when the determination in Step S106 in FIG. 6 in the fourth embodiment is “NO”. The fifth embodiment is different from the fourth embodiment in this respect, but the fifth embodiment and the fourth embodiment are common to each other in other respects. It is to be noted that the processing in Fifth Embodiment is similar to that described later in FIG. 15.

According to the fifth embodiment, when the determination processing unit 113 (refer to FIG. 2) determines that discharge is occurring at the insulated portion 27, the control processing unit 114 forcibly stops the abnormality monitored device 2. By this operation, the processing device 1 can sense the discharge of the insulated portion 27 and stops the abnormality monitored device 2 safely. In addition, since the operator does not drive the abnormality monitored device 2 while discharge is occurring at the insulated portion 27, parts of the abnormality monitored device 2 can be prevented from damage.

### Sixth Embodiment

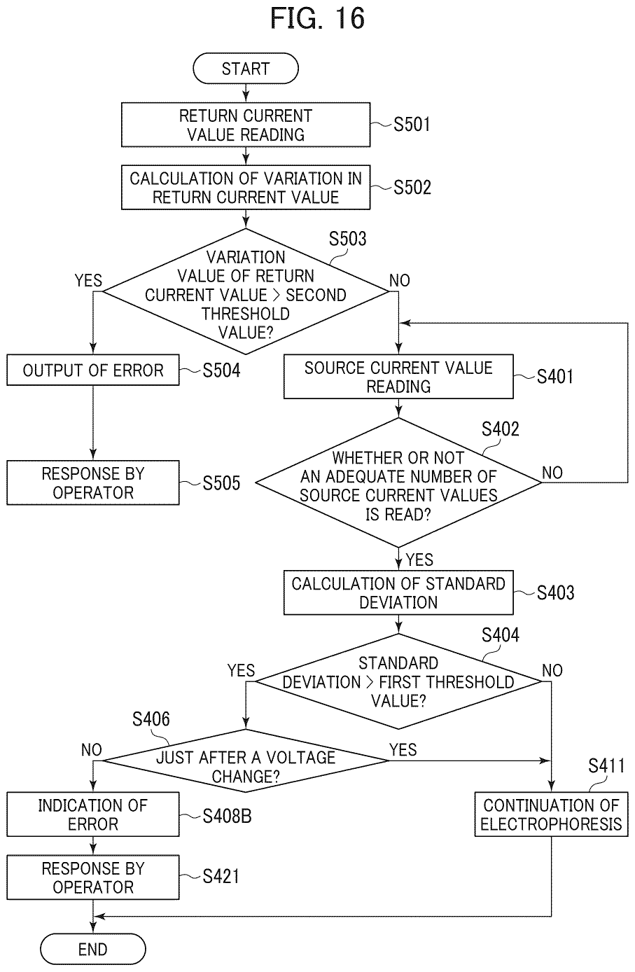

What is described above in the fourth embodiment is an abnormality sensing method for checking whether or not abnormality is occurring at the physical path 26 of the abnormality monitored device 2. In the sixth embodiment, on the other hand, when occurrence of discharge is sensed at the insulated portion 27, error outputting processing by the output processing unit 115 (refer to FIG. 2) is added. Although not shown, processing in which the output processing unit 115 outputs an error when the determination processing unit 113 determines “No” in Step S106 in FIG. 6 in the fourth embodiment is added. The sixth embodiment is different from the fourth embodiment in this respect, but the sixth embodiment and the fourth embodiment are common to each other in other respects. In the sixth embodiment, when discharge is sensed at the insulated portion 27, the output processing unit 115 outputs an error. by this, the operator can find the occurrence of discharge at the insulated portion 27 of the abnormality monitored device 2. The processing to be performed in the sixth embodiment is similar to that shown later in FIG. 16.

### Seventh Embodiment

Next, the seventh embodiment will be described referring to FIG. 7A to FIG. 9. In the seventh embodiment, the capillary electrophoresis apparatus 300 in which the abnormality sensing method shown in the first embodiment has been loaded will be described.

In the embodiments described hereinafter, a source current is used to sense the discharge at the insulated portion 27 (refer to FIG. 1) which is outside the flow path of a sample in the capillary electrophoresis apparatus 300 shown in FIG. 7A. The processing device 1 uses a source current value and calculates a standard deviation. Then, the processing device 1 determines the discharge at the insulated portion 27 by whether the calculated standard deviation exceeds a threshold value or not. The processing device 1 that carries out this determination is connected to the capillary electrophoresis apparatus 300 and therefore, the processing device 1 senses the discharge generated in the capillary electrophoresis apparatus 300.

### Capillary Electrophoresis System 3

FIG. 7A is a device constitution diagram showing one example of a capillary electrophoresis system to be used in the seventh embodiment. FIG. 7B is an enlarged view of a portion indicated by the code Y in FIG. 7A and it is an enlarged view of an end portion of a hollow electrode 313.

The capillary electrophoresis system 3 is constituted of the capillary electrophoresis apparatus 300 and the control computer 400.

The capillary electrophoresis apparatus 300 has a sensing unit 301 for optically sensing a sample and an oven (thermostatic bath) 351 for keeping the temperature of a capillary 312. In addition, the capillary electrophoresis apparatus 300 has an autosampler 330 for transporting various containers to a cathode edge 312A (refer to FIG. 7B) of the capillary 312. Further, the capillary electrophoresis apparatus 300 has a high voltage power source 23A for applying a high voltage DC to the capillary 312.

### Abnormality Sensing System

The capillary electrophoresis apparatus 300 has a source current meter 21 for sensing a current emitted by applying a voltage by the high-voltage power source 23A. In addition, the capillary electrophoresis apparatus 300 has a return current meter 22 for sensing a current that flows to an anode electrode 342A.

As the high-volage power source 23A, the source current meter 21, and the return current meter 22, those originally possessed by the capillary electrophoresis apparatus 300 are used. It is to be noted that the high voltage power source 23A corresponds to the power source 23 shown in FIG. 1.

### Capillary Array 311

Further, the capillary electrophoresis apparatus 300 has a capillary array 311 constituted of one or more capillaries 312.

The capillary electrophoresis apparatus 300 further has a pump mechanism unit 320 or polymer transporting unit for pouring, into the capillary array 311, a highly viscous polymer solution (which will hereinafter be called “polymer”) which is an electrophoresis medium. The capillary electrophoresis apparatus 300 further has a load header 331 and a capillary head 321.

The capillary array 311 has, as described above, one or more capillaries 312. In the example shown in FIG. 7A, the capillary array 311 is constituted of eight capillaries 312. The capillary array 311 is a replaceable member.

When a measuring method is changed, that is, when a sample is changed, the operator replaces the capillary array 311 with another one and adjust the length of the capillary array 311.

When in the capillary array 311, breakage or quality deterioration occurs, the operator replaces it with a new one. The capillary 312 is constituted of a glass tube having an inner diameter of several tens to several hundred microns and an outer diameter of several hundred microns. The capillary 312 has a surface coated with polyimide to have improved strength. From the sensing unit 301 to be exposed to a laser light, a polyimide coating is removed to accelerate leakage of internal luminescence to the outside.

The capillary 312 is filled with a polymer which is a Separation medium for giving an electrophoresis speed difference at the time of electrophoresis. The polymer has both fluidity and non-fluidity.

In the load header 331, a metallic hollow electrode 313 is attached to each of the capillaries 312 (refer to FIG. 7B). As shown in FIG. 7B, the end of the capillary 312 protrudes by about 0.5 mm from the hollow electrode 313.

All the hollow electrodes 313 are electrically communicated with the high-voltage power source 23A loaded on the capillary electrophoresis apparatus 300. The hollow electrode 313 operates as a cathode electrode when voltage application is required at the time of electrophoresis, sample introduction or the like.

The load header 331 is fixed on the oven 351. The ends (anode edges) of the capillary 312 positioned on the side of the capillary 312 opposite to the cathode edge 312A (refer to FIG. 7) are bundled into one by the capillary head 321. The capillaries 312 can be detached from the capillary head 321 as a pressure-resistant and air-tight bundle.

### Pump Mechanism Unit 320

The pump mechanism unit 320 has a pump 322 having a plunger and a block 323 having a flow path inside thereof.

The flow path provided inside the block 323 has an inner diameter of from 0.5 to 2 mm and is larger by several to several ten times than that of the capillary 312. This makes it possible to avoid generation of a voltage loss during electrophoresis. To the block 323, connected are the pump 322, the capillary head 321, a first tube 343a, and a second tube 343b. The pump 322, the capillary head 321, the first tube 343a, and the second tube 343b are connected to each other by a flow path provided inside the block 323. The first tube 343a connects between the block 323 and the polymer contained in a polymer bottle 341.

The pump 322 sucks, via the first tube 343a, the polymer from the polymer bottle 341 that stores therein the polymer. The pump 322 sucks, via the second tube 343b, a buffer solution from an anode buffer container 342. In the buffer solution in the anode buffer container 342, the anode electrode 342A is immersed. The polymer bottle 341 stores therein the polymer in an amount sufficient and necessary for continuous operation. The polymer bottle 341 has an exhaust valve (not shown) to prevent the pressure in the polymer bottle 341 from becoming negative even if the polymer is sucked from the polymer bottle 341. Alternatively, the polymer bottle 341 has a space sufficiently large as an insertion port of the first tube 343a.

The first tube 343a has a check valve 344. The second tube 343b connects between the block 323 and the buffer solution contained in the anode buffer container 342. The second tube 343b has an electrically-driven buffer valve 345. Although not clearly shown in FIG. 7A, the polymer bottle 341 is placed at a position lower than the anode buffer container 342. They are placed as described above and make use of a pressure due to difference in height to prevent the backflow of the polymer from the polymer bottle 341 to the anode buffer container 342. On the contrary, the backflow of the polymer or buffer solution from the anode buffer container 342 to the polymer bottle 341 is prevented by the check valve 344.

When the polymer is poured in the capillary 312 of the capillary array 311, the buffer valve 345 is closed. By this closure, the flow path between the capillary array 311 and the anode buffer container 342 is closed. The polymer stored in the polymer bottle 341 is poured in the capillary 312 by driving the pump 322 while closing the flow path. When electrophoresis is performed, the buffer valve 345 is opened and the flow path between the capillary array 311 and the anode buffer container 342 is connected.

### Optical Sensing System

The optical sensing system is constituted of a light source 302 to which the sensing unit 301 is exposed and an optical sensor 303 for sensing light generated at the sensing unit 301.

The sensing unit 301 is a member for acquiring information which is dependent on a sample such as fluorescent material-added DNA. The capillaries 312 are arranged and fixed on an optical flat plane with accuracy, in height, of several microns in the vicinity of the sensing unit 301. During electrophoresis, a laser light having the same axis is irradiated from the light source 302. The laser light with which the capillaries are irradiated passes all the capillaries 312 continuously. By this laser light, an information light (fluorescence having a wavelength dependent on the sample) is generated from the sample and emitted outside from the sensing unit 301. The optical sensor 303 senses this information light. An analyzer which is not shown analyses the information light and thus, analyzes the sample.

### Autosampler 330

The autosampler 330 is movable in three axis directions, that is, vertical, horizontal, and depth directions. On a moving stage 334 of the autosampler 330, a cathode buffer container 332, a sample container 333, and the like are placed. By this structure, the autosampler 330 can transport the cathode buffer container 332, the sample container 333, and the like as needed. It is to be noted that the sample container 333 contains a sample liquid in which a sample is mixed.

### Control System and Processing System

The capillary electrophoresis apparatus 300 is used while being connected to the control computer 400 with a communication cable. The operator operates the control computer 400 and thereby controls the function which the capillary electrophoresis apparatus 300 has. In addition, the control computer 400 can give and receive the data sensed at the sensing unit 301 which the capillary electrophoresis apparatus 300 has. The control computer 400 can stop the capillary electrophoresis apparatus 300.

The control computer 400 and the capillary electrophoresis apparatus 300 are separate devices in the example shown in FIG. 7A, but the control computer 400 and the capillary electrophoresis apparatus 300 may be united into one.

The processing device 1 acquires a source current value from the source current meter 21 and at the same time, acquires a return current value from the return current meter 22. The processing device 1 senses the discharge of the insulated portion 27 or abnormality of the physical path 26 based on the thus-acquired source current value or return current value. When the processing device 1 senses the discharge at the insulated portion 27, it outputs an error or instructs the control computer 400 to stop the capillary electrophoresis apparatus 300.

As shown in FIG. 7A, the source current meter 21 is connected to the load header 331. The return current meter 22 is connected, in the anode buffer container 342, the anode electrode 342A immersed in the buffer solution.

In the present embodiment, the processing device 1 and the control computer 400 are installed as respectively separate devices, but the processing device 1 and the control computer 400 may be united into one.

The following flow: the anode electrode 342A→the buffer solution contained in the anode buffer container 342→the second tube 343b→the capillary head 321→the capillary 312→the load header 331 corresponds to the physical path 26 shown in FIG. 1. The insulated portion 27 shown in FIG. 1 mainly corresponds to a portion between the load header 331 and the cathode buffer container 332 or between the load header 331 and the cathode buffer container 332 contained in the buffer solution. The position of the cathode buffer container 332 is controlled by the autosampler 330. During position control, some setting mistake or the like inevitably increases the distance between the cathode buffer container 332 and the load header 331. Under such a state, discharge occurs between the load header 331 and the cathode buffer container 332 or between the load header 331 and cathode buffer container 332 contained in the buffer solution.

The load header 331 corresponds to the negative electrode terminal 24 shown in FIG. 1 and the anode electrode 342A corresponds to the positive electrode terminal 25 shown in FIG. 1. In FIG. 1, the source current meter 21 and the voltage source 23 are connected to the positive electrode terminal 25 and the return current meter 22 is connected to the negative electrode terminal 24. In the example shown in FIG. 7A, on the other hand, the return current meter 22 is connected to the anode electrode 342A corresponding to the positive electrode terminal 25 shown in FIG. 1. The source current meter 21 and the high-voltage power source 23A (voltage source 23 shown in FIG. 1) are connected to the load header 331 corresponding to the negative electrode terminal 24 shown in FIG. 1. As described above, the structure may be that the source current meter 21 is connected to the side of the voltage source 23 relative to the physical path 26 and the return current meter 22 is connected to the opposite side. For example, the source current meter 21 and the return current meter 22 may be connected to either one of the negative electrode terminal 24 and the positive electrode terminal 25.

### Voltage Control Circuit

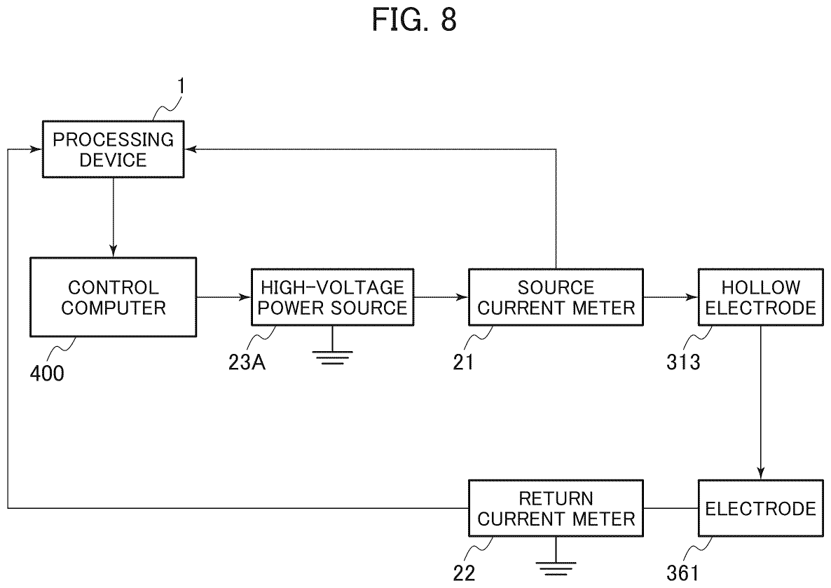

FIG. 8 is a view showing a voltage control circuit for carrying out voltage control of the capillary electrophoresis apparatus 300.

The voltage control circuit has the processing device 1, the control computer 400, the high-voltage power source 23A, the source current meter 21, and the return current meter 22. The high-voltage power source 23A applies a voltage to the physical path 26 based on the control of the processing device 1. The high voltage power source 23A corresponds to the voltage source 23 shown in FIG. 1. It is to be noted that the physical path 26 is as described above.

The electrophoresis path corresponds to the capillary array 311, a flow path provided in the block 323, and the polymer with which the second tube 343b is filled.

The high-voltage power source 23A is communicated with an electrode 361 via the source current meter 21, the hollow electrode 313, and the return current meter 22. The electrode 361 corresponds to the negative electrode terminal 24 shown in FIG. 1 or the anode electrode 342A in FIG. 7. When a voltage of several ten kilovolts is applied at one end of the source current meter 21, a voltage difference of several tens kilovolts appears at both ends of the source current meter 21 and the electrode 361. By this application, an electric field appears in the direction from the hollow electrode 313 to the electrode 361. The sample charged negatively by this electric field moves from the cathode edge 312A (refer to FIG. 7B) of the capillary 312 to the sensing unit 301.

Then, the source current meter 21 measures a source current value that flows from the high-voltage power source 23A to the hollow electrode 313 and transmits the thus-measured source current value to the processing device 1. The return current meter 22 measures a return current value that flows from the electrode 361 to GND and transmits the thus-measured return current value to the processing device 1.

The processing device 1 reads the source current value from the source current meter 21 and the return current value from the return current meter 11 and carries out calculation, that is, carries out an abnormality sensing method. The processing device 1 then sends an instruction to the control computer 400 according to the results of the abnormality sensing method. By the control computer 400, forcible voltage shut-off of the high-voltage power source 23A is performed and the capillary electrophoresis apparatus 300 is stopped. The processing device 1 can mutually communicate with the control computer 400 placed outside the capillary electrophoresis apparatus 300.

Next, preparation before start of electrophoresis will be described referring to FIGS. 7A and 7B as needed.

The operator sets the following containers in the capillary electrophoresis apparatus 300 before measurement by the capillary electrophoresis apparatus 300 is started.

The anode buffer container 342 containing a buffer solution.

The cathode buffer container 332 in which a container for capillary washing liquid and a waste liquid container for discharging the polymer in the capillary 312 are integrated into one.

A polymer container 116 containing a polymer which will be a separation medium. A sample container containing a sample to be measured.

The operator fills the anode buffer container 342 with a sufficient amount of a buffer solution with which both the anode electrode 342A and the second tube 343b are immersed therewith. The operator also ensures that the cathode buffer container 332 contains a buffer solution in an amount sufficient for immersing the hollow electrode 313 and the cathode edge 312A of the capillary 312 therewith.

When measurement is started without a sufficient amount of the buffer solution, there is a possibility of discharge occurring between a high-potential cathode and a low-potential thing at the time of high voltage application. The electrophoresis path or a flow path to be used for transporting the polymer is all filled with the polymer before the measurement is started.

### Analysis Processing

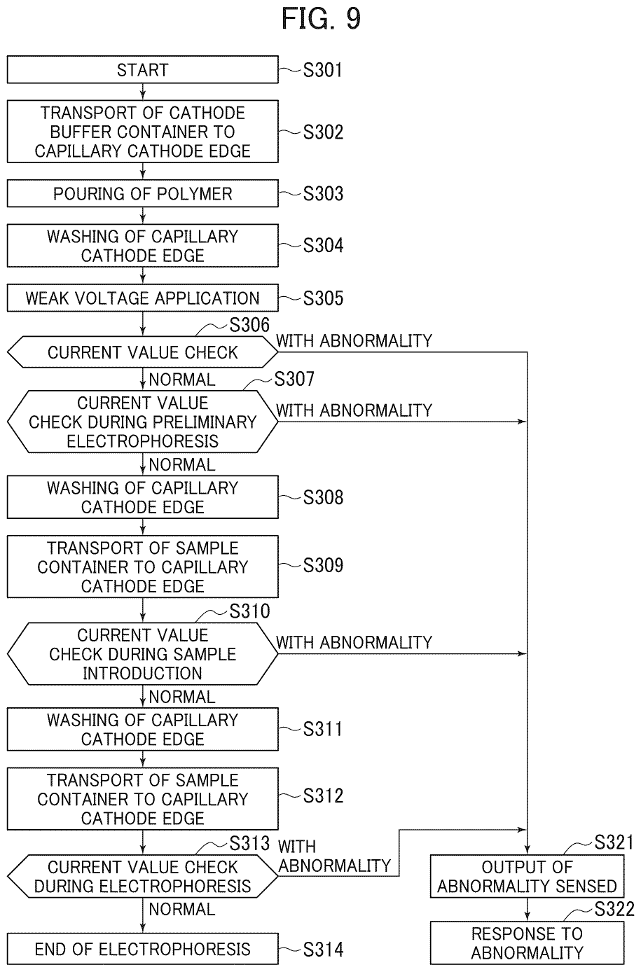

FIG. 9 is a flowchart showing one example of processing procedures from the start to the end of analysis using the capillary electrophoresis apparatus 300. Refer to FIGS. 1, 7A, and 7B as needed.

The capillary electrophoresis apparatus 300 starts analysis by the order sent from the control computer 400 (S301).

Next, in preparation for pouring of the polymer into the capillary 312, the autosampler 330 loaded on the capillary electrophoresis apparatus 300 transports the cathode buffer container 332 to the cathode edge 312A of the capillary 312 (S302).

Then, the polymer is poured (S303) into the capillary 312 by the pump mechanism unit 320 which the capillary electrophoresis apparatus 300 has.

In addition, the cathode edge 312A of the capillary array 311 (capillary 312) is washed (S304).

And, the presence or absence of abnormality in the capillary electrophoresis apparatus 300 is checked. In the check of the presence or absence of abnormality, the high-voltage power source 23A applies a week voltage (S305).

Then, the processing device 1 carries out current value check (S306) and determines whether or not abnormality is occurring in the capillary electrophoresis apparatus 300. The details of the current value check performed in Step S306 will be described later. The current value to be checked in Step S306 is either a source current value or a return current value. By checking the current value in the stage of Step S306 and thereby sensing abnormality in Step S306, the operator can stop the processing subsequent thereto. This makes it possible to prevent application of a high voltage to the physical path 26 while abnormality is occurring and at the same time, prevent waste of the sample or the like.

When the processing device 1 determines that abnormality occurs as the result of current value check (S306→with abnormality), the processing device 1 outputs that abnormality sensing (S321). The output of abnormality sensing means output of an error or output of an alert. After Step S321, a reaction to the abnormality is performed (S322). The reaction to the abnormality means a reaction by an operator or stopping of the capillary electrophoresis apparatus 300.

It is however not always necessary to carry out the step S321 or S322.

The weak voltage to be applied in Step S305 is a voltage lower than a power source to be applied by the high-voltage power source 23A in preliminary electrophoresis, sample introduction, and electrophoresis which will be described later. A voltage to be applied in Step S305 is several kV and is generally presumed to be a high voltage.

In the stage of Step S306, when the operator finds that abnormality is occurring in the capillary electrophoresis apparatus 300, it is possible to reduce the damage of the part of the capillary electrophoresis apparatus 300.

When the capillary electrophoresis apparatus 300 has no abnormality in Step S306 (S306→without abnormality), the high-voltage power source 23A applies a voltage predetermined for the flow path of the sample and thereby the processing device 1 performs preliminary electrophoresis. At this time (at the time of preliminary electrophoresis), a current value check is performed (S307). The preliminary electrophoresis is performed, prior to an actual analyzing step including procedures from sample introduction to electrophoresis, to make the state of the polymer, with which the capillary 312 is filled, suited for the analysis.

During the preliminary electrophoresis, a voltage of from about several to several ten kilovolts is applied to a current path for several to several ten minutes.

When the processing device 1 determines that there is abnormality (S307→with abnormality) by the current check during the preliminary electrophoresis, steps S321 and S322 are executed. The current value check is performed in the stage of Step S307 and therefore, the current value check is performed before sample introduction. This means that abnormality determination of the capillary electrophoresis apparatus 300 can be performed simultaneously with the preliminary electrophoresis. By carrying out abnormality sensing of the capillary electrophoresis apparatus 300 at the time of preliminary electrophoresis introduction, the electrophoresis can be stopped before sample introduction. This makes it possible to prevent wasting of the sample.

When the preliminary electrophoresis is finished (the processing device 1 determines that there is no abnormality by the current check during preliminary electrophoresis: S307→without abnormality), the cathode edge 312A of the capillary 312 is washed with a buffer solution (S308). Then, the autosampler 330 transports the sample container 333 to the cathode edge of the capillary 312 (S309).

When to the sample solution housed in the sample container 333, the high-voltage power source 23A applies a voltage of about several kilovolts to the cathode electrode of the capillary 312, an electric field is generated between the sample solution to the cathode-side electrode. By this electric field, the sample in the Sample solution is introduced into the capillary 312. At this time, the processing device 1 checks the current value at the time of sample introduction.

When the device is determined to have abnormality (S310 with abnormality) as the result of current value check at the time of sample introduction, processing of Steps S321 and S322 is performed. By carrying out current value check in the stage of Step S310, current value checked is performed before electrophoresis. This means that sample introduction and abnormality determination of the capillary electrophoresis apparatus 300 can be performed simultaneously. In addition, since abnormality sensing of the capillary electrophoresis apparatus 300 is performed at the time of sample introduction, electrophoresis can be stopped before electrophoresis.

When sample introduction is finished (the processing device 1 determines that there is no abnormality as the result of current check at the time of sample introduction: S310→without abnormality), the cathode edge 312A of the capillary 312 is washed with a buffer solution (S311).

Then, by the autosampler 330, the cathode buffer container 332 is transported (S312) to the cathode edge 312A of the capillary 312. Then, the high-voltage power source 23A applies a predetermined voltage to the buffer solution stored in the cathode buffer container 332 to start electrophoresis. At this time, the voltage value check at the time of electrophoresis is performed (S313).

When the device is determined to have abnormality by the voltage value check at the time of electrophoresis (S313→with abnormality), processing in Steps S321 and 322 are performed.

In electrophoresis, mobility is given to the sample in the capillary 312 by the action of an electric field generated between the cathode edge 312A of the capillary 312 and the anode electrode 342A. As the result, the sample is separated due to a mobility difference depending on the properties of the sample. The sample which is moving after being separated is optically sensed in order of arrival at the sensing unit 301. For example, when the sample is a DNA, there occurs a difference in mobility depending on its base length and therefore, a DNA having a shorter base length and therefore having a higher moving rate passes the sensing unit 301 earlier. Since the DNA has been attached with a fluorescent material in advance, it is optically sensed at the sensing unit 301. The measurement time and voltage application time are typically set to fit a sample whose electrophoresis time is the longest.

As shown in Step S313 in FIG. 9, the current value check may also be performed in the stage of electrophoresis. In electrophoresis, a high voltage should be applied for long hours. When application of a high voltage to an abnormal portion is continued for long hours while the capillary electrophoresis apparatus 300 has abnormality, the portion where abnormality occurs or a peripheral part thereof is damaged. When abnormality of the capillary electrophoresis apparatus 300 is sensed during electrophoresis, damage of the part can be avoided by stopping the capillary electrophoresis apparatus 300 or informing the operator of it as an error.

When the processing device 1 determines that there is no abnormality (S313→without abnormality) by the current value check at the time of electrophoresis and a predetermined time has passed since the start of voltage application, an analyzing device not shown finishes acquiring scheduled data. Then, the high-voltage power source 23A stops voltage application and thus, electrophoresis is finished (S314). The analyzing device analyses the thus-acquired data (results of electrophoresis) to finish analysis.

The steps described above are a series of measurement sequences.

The current value check performed in Steps S307, S310, and S313 can be omitted. By carrying out the current value check in the stages of Steps S307, S310, and S313, the presence or absence of abnormality of the capillary electrophoresis apparatus 300 can be determined in respective stages.

### Current Value Check

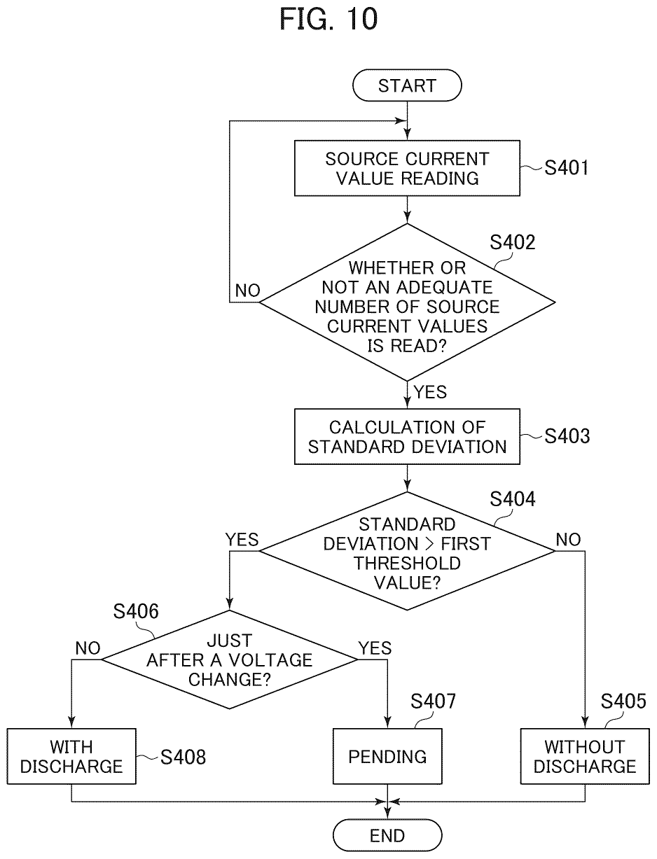

Next, a method of current value check will be described referring to FIG. 10. The current value check shown in FIGS. 10 to 16 is processing performed in Step S306 in FIG. 9 and if necessary, processing performed in each step of S307, S310, and S313.

In other words, the current value check performed in FIGS. 10 to 16 is performed (Step S306 in FIG. 9) before the preliminary electrophoresis of the capillary electrophoresis apparatus 300.

The current value check performed in FIGS. 10 to 16 is performed at the timing of at least one of the preliminary electrophoresis, sample introduction, and electrophoresis of the capillary electrophoresis apparatus 300. The current value check performed in FIGS. 10 to 16 is a standard deviation calculation step, a first determination step, a second current value reading step, or a second determination step.

FIG. 10 is a flowchart showing one example of processing procedures of checking a current value. In the description of FIGS. 10 to 16, FIGS. 2 and 7A are referenced as needed.

A series of processing shown in FIG. 10 is the processing shown in FIG. 5 and applied to the capillary electrophoresis system 3.

By the application of a voltage (S305 and the like in FIG. 9) in the capillary electrophoresis apparatus 300, measurement of a source current value and a return current is started and the source current value is read (S401). Step S401 is a first current value reading step. In the case of the capillary electrophoresis system 3 shown in FIG. 7A, however, discharge rarely occurs because the return current meter 22 is connected to GND. In the seventh embodiment, the return current value is not used. The source current value is sampled by a method as shown in FIG. 4.

Next, it is determined (S402) whether or not the calculation unit 112 reads a source current value enough times, that is, a set number of times (10 times according to the example shown in FIG. 4).

When the source current value is not read a set number of times (S402), the processing device 1 returns the processing to Step S401.

When the source current value is read a set number of times (S402→Yes), the calculation unit 112 uses each of the source current values thus read and calculates a standard deviation per unit time (S403). Step S403 is a standard deviation calculation step.

The determination processing unit 113 determines whether or not the standard deviation per unit time is larger than the first threshold value (S404: first determination step).

In the case of the seventh embodiment, the processing device 1 reads and checks the variation of the source current value with a cycle of 100 msec while a voltage is applied to the physical path 26 (refer to FIG. 4). The calculation unit 112 calculates (S403) a standard deviation based on several source current values sampled. For example, in the example shown in FIG. 4, ten source current values are sampled in 1 sec and the calculation unit 112 calculates a standard deviation of ten source current values thus sampled. Consequently, the calculation unit 112 therefore calculates a standard deviation in one sec (meaning per unit time). As described above in FIGS. 3A to 3C, when discharge occurs at the insulated portion 27 (meaning a portion between the load header 331 and the cathode buffer container 332 or the buffer solution, shown in FIG. 7A), there occurs variation in source current value (standard deviation). The standard deviation of the source current value therefore becomes larger compared with the case where no discharge is occurring at the insulated portion 27.

In the seventh embodiment, therefore, a first threshold value is set as a certain threshold value and the determination processing unit 113 determines (S404) whether or not the standard deviation calculated in Step S403 is larger than the first threshold value. The operator decides the first threshold value.

For example, the kind of the capillary electrophoresis apparatus 300 (CCE, 3500, or the like), the length of the capillaries 312, the number of capillaries 312, the kind of the polymer used, and the like which are parameters having an influence on the source current value are considered.

When the standard deviation exceeds the first threshold value (S404→Yes) in Step S404, the determination processing unit 113 determines whether or not the present current value is that immediately after a change in applied voltage (S406: exclusion step). When the current value is immediately after a change in applied voltage (S406→Yes), the determination processing unit 113 determines that the change in source current value is not caused by the discharge at the insulated portion 27. This is because, as described above, immediately after a change in applied voltage, a change in the source current value (and the return current value) occurs according to Ohm's rule with the change in applied voltage.

When the present current value is that immediately after a change in applied voltage (S406→Yes), the determination is pended (S407: Exclusion step). When the present current value is immediately after a change in applied voltage, therefore, the source current value thus measured is excluded from the determination of the discharge at the insulated portion 27.

For example, the source current values corresponding to three seconds (100 msec×30) immediately after a change in applied voltage are excluded from the determination of the discharge at the insulated portion 27. The operator decides the term how long the source current values are not used immediately after the change in applied voltage. For example, the kind of the capillary electrophoresis apparatus 300 (CCE, 3500, or the like), the length of the capillaries 312, the number of capillaries 312, the kind of the polymer used, and the like which are parameters having an influence on the source current value are considered.

When as the result of Step S406, the present current value is not that immediately after a change in applied voltage (S406→No), the determination processing unit 113 determines that discharge is occurring at the insulated portion 27. In this case, the control processing unit 114 may stop the capillary electrophoresis apparatus 300 or the output processing unit 115 may output an error or an alert.

When the standard deviation value is not greater than the first threshold value (S404→No) in Step S404, it is determined that no discharge is occurring at the insulated portion 27 (S408).

According to the seventh embodiment, the abnormality sensing method performed in the first embodiment can be applied to the capillary electrophoresis system 3.

### Eighth Embodiment

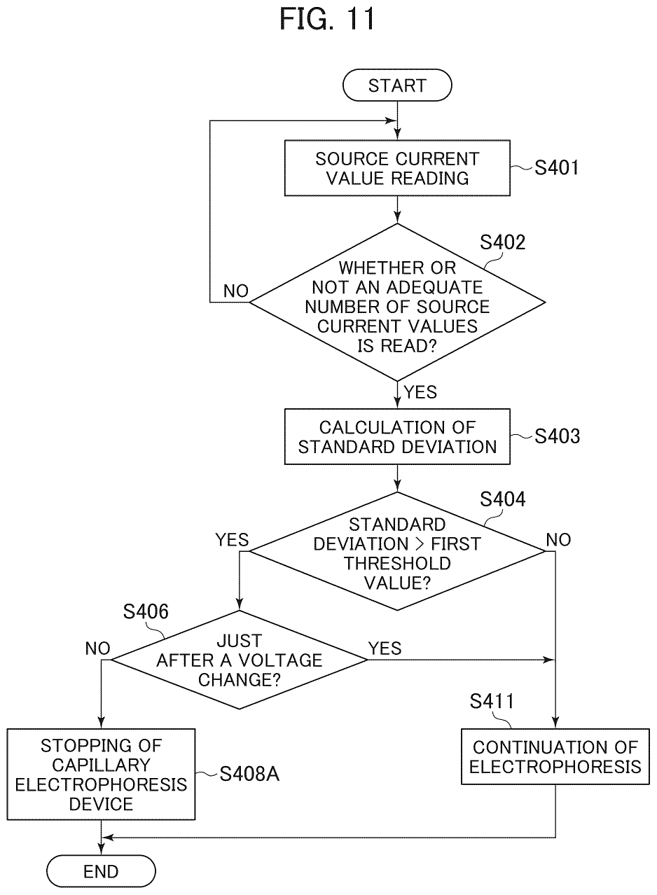

Next, the eighth embodiment of the present invention will be described referring to FIG. 11.

FIG. 11 is a flowchart showing an example of processing procedures according to the eighth embodiment.

In the seventh embodiment described above, described is the sensing method for determining whether or not discharge is occurring at the insulated portion 27 in the capillary electrophoresis apparatus 300. In the eighth embodiment, on the other hand, described is, as a method when discharge at the insulated portion 27 is sensed, the stopping of the capillary electrophoresis apparatus 300.

In the present embodiment, as shown in FIG. 11, when determination “No” is made in Step S406, the control processing unit 114 forcibly stops the capillary electrophoresis apparatus 300. (S408A: Stop Control Processing Step) This means that when occurrence of discharge is sensed at the insulated portion 27, the control processing unit 114 forcibly stops the capillary electrophoresis apparatus 300 which is an abnormality monitored device 2.

When the determination is “No” in Step S404 or is “Yes” in Step S406, the electrophoresis is continued (S411). In other words, in FIG. 10, when determination is pended (S407) or determination is “without discharge” (S408), electrophoresis is continued without stopping the capillary electrophoresis apparatus 300. It is to be noted that the electrophoresis means the processing shown in FIG. 9.

The eighth embodiment is different from the seventh embodiment in the above-described respect, but is common to the seventh embodiment in other respects. According to the eighth embodiment, when it is determined that discharge is occurring at the insulated portion 27, the control processing unit 114 forcibly stops the capillary electrophoresis apparatus 300. By this operation, the processing device 1 can sense the discharge of the insulated portion 27 and stops the capillary electrophoresis apparatus 300 safely. In addition, since the operator does not drive the capillary electrophoresis apparatus 300 while discharge is occurring at the insulated portion 27, parts of the capillary electrophoresis apparatus 300 can be prevented from damage.

### Ninth Embodiment

Next, the ninth embodiment of the present invention will be described referring to FIG. 12.

FIG. 12 is a flowchart showing an example of processing procedures according to the ninth embodiment.

It is described in the eighth embodiment that when discharge is occurring at the insulated portion 27, the control processing unit 114 stops the capillary electrophoresis apparatus 300. In the ninth embodiment, on the other hand, the output processing unit 115 outputs “error” instead of stopping the capillary electrophoresis apparatus 300.

In the present embodiment, when the determination “No” is made in Step S406, the output processing unit 115 causes the output device 15 to output “error” (FIG. 2). S408B: error output (error output step) Then, the operator responds to it. (S421)

The ninth embodiment is different from the eighth embodiment in the above-described respect, but is common to the seventh embodiment in other respects. In the ninth embodiment, when occurrence of discharge at the insulated portion 27 is sensed, the output processing unit 115 carries out error output to the output device 15. By this, the operator can find the occurrence of discharge at the insulated portion 27 of the capillary electrophoresis apparatus 300.

### Tenth Embodiment

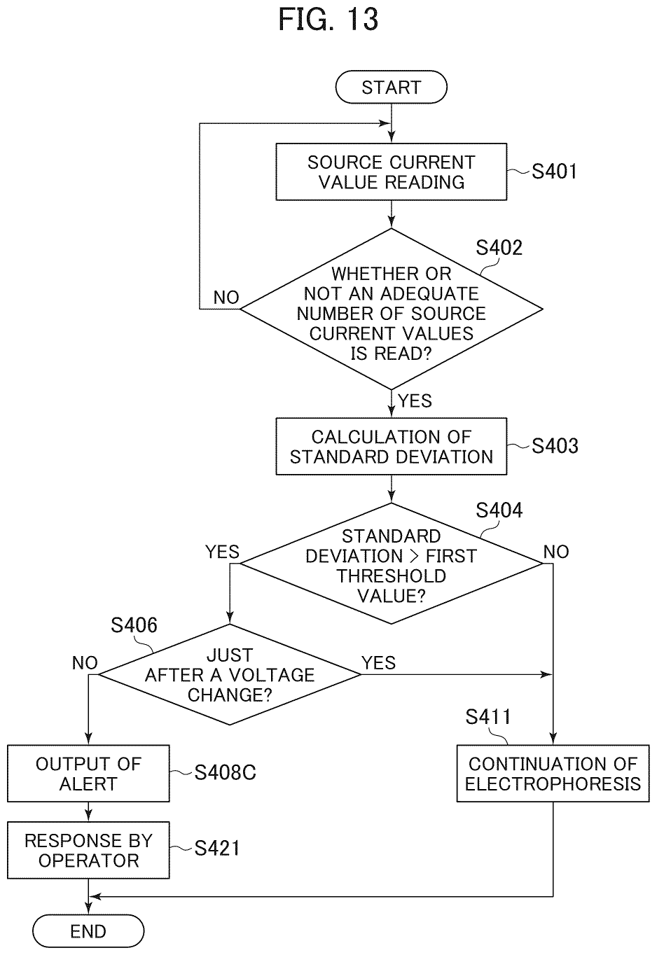

Next, the tenth embodiment of the present invention will be described referring to FIG. 13.

FIG. 13 is a flowchart showing an example of processing procedures according to the tenth embodiment.

In the ninth embodiment, when discharge is occurring at the insulated portion 27, the output processing unit 115 outputs “error”. In the tenth embodiment, on the other hand, the unit outputs “alert” as one specific example of “error” (S408C). The tenth embodiment is different from the ninth embodiment in the above-described respect, but is common to the ninth embodiment in other respects. In the tenth embodiment, when it is determined that the discharge is occurring at the insulated portion 27, the output processing unit 115 outputs “alarm” as the output of “error”. By this, the operator can find the occurrence of discharge at the insulated portion 27 of the capillary electrophoresis apparatus 300.

### Eleventh Embodiment

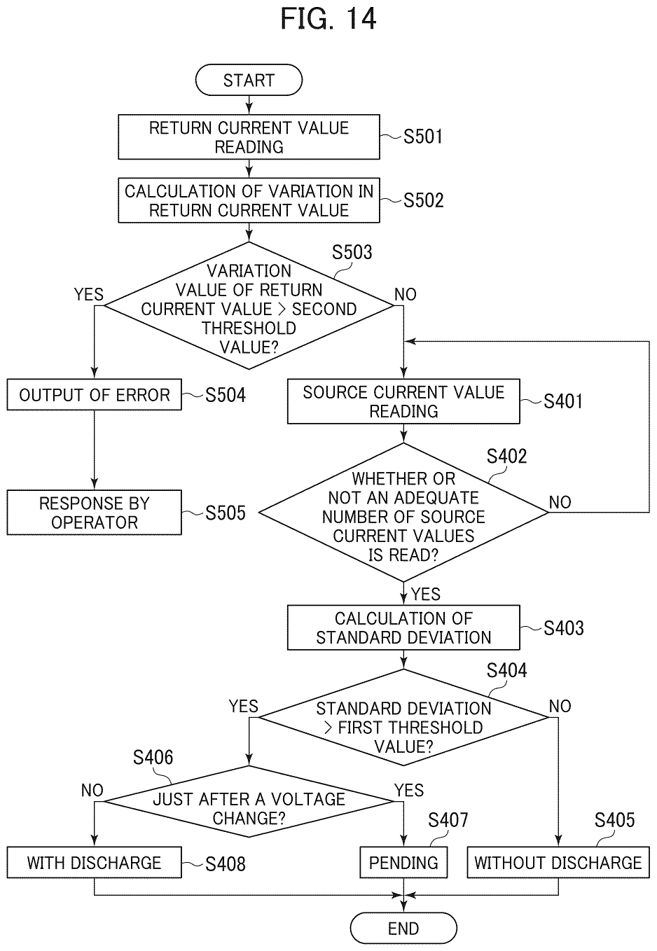

Next, the eleventh embodiment of the present invention will be described referring to FIG. 14.

FIG. 14 is a flowchart showing an example of processing procedures according to the eleventh embodiment.

In the seventh embodiment, only the discharge at the insulated portion is sensed by measuring a source current value.

The eleventh embodiment includes S501 to S505 each abnormality sensing processing of a return current value. In the flowchart shown in FIGS. 14 to 16, the return current meter 22 is not connected to GND.

This means that the return current meter 22 reads a return current value (S501: second current value reading step).

Next, the calculation unit 112 calculates the variation value of the return current value (S502). More specifically, the determination processing unit 113 calculates a difference between the return current value read previously and the return current value read currently.

The determination processing unit 113 then determines whether or not the variation value of the return current value is greater than the second threshold value (S503: second determination step). When the variation value of the return current value is greater than the second threshold value (S503→Yes), the determination processing unit 113 determines that abnormality is occurring at the physical path 26 and the output processing unit 115 outputs “error”. (S504: Second Determination Step) The abnormality of the physical path 26 means occurrence of discharge or conduction failure which is caused by mixing of air bubbles or the like in the flow path. After Step S504, the operator responds to it by bubble removing or the like (S505).

When the variation value of the return current value is not greater than the second threshold value (S503→No), the source current meter 21 carries out reading of a source current value (S401). Steps after Step S401 are similar to those described in FIG. 10 so that description on them is omitted.

The eleventh embodiment is different from the seventh embodiment in the respect that it has Steps S501 to S505, but is common to the seventh embodiment in other respects. In the eleventh embodiment, only discharge is sensed by measuring the source current value. On the other hand, in the eleventh embodiment, abnormality sensing processing of a return current value shown in Steps S501 to S504 is performed. The abnormality of the physical path 26 sensed based on the variation value of the return current value is discharge or conduction failure which is caused by mixing of air bubbles or dust in a flow path such as capillary 312. The eleventh embodiment is different from the seventh embodiment in that the former one has Steps S501 to S504, but is common to the seventh embodiment in other respects. Since Steps S501 to S504 are performed, when air bubbles or dust is mixed a flow path of a sample, abnormality of the return current value due to this flow path (physical path 26) is output as “error” (S504). The operator can then respond to it (S505) by bubble removing or the like.

### Twelfth Embodiment

Next, the twelfth embodiment of the present invention will be described referring to FIG. 15.

FIG. 15 is a flowchart showing an example of processing procedures according to the twelfth embodiment.

What is described above in the eleventh embodiment is a method of sensing whether or not abnormality is occurring at the physical path 26. In the twelfth embodiment, when discharge is occurring at the insulated portion 27, that is, when determination “No” is made in Step S406, the control processing unit 114 forcibly stops the capillary electrophoresis apparatus 300 (S408A). When the determination is “No” in Step S404 or is “Yes” in Step S406, the electrophoresis is continued (S411). The twelfth embodiment is different from the eleventh embodiment in these respects, but is common to the eleventh embodiment in other respects. According to the twelfth embodiment, when it is determined that discharge is occurring at the insulated portion 27, the control processing unit 114 forcibly stops the capillary electrophoresis apparatus 300. Thus, since the operator does not operate the capillary electrophoresis apparatus 300 when discharge is occurring, parts of the capillary electrophoresis apparatus 300 can be prevented from damage.

### Thirteenth Embodiment

Next, the thirteenth embodiment of the present invention will be described referring to FIG. 16.

FIG. 16 is a flowchart showing an example of processing procedures according to the thirteenth embodiment.

In the twelfth embodiment, described is a method in which the control processing unit 114 stops the capillary electrophoresis apparatus 300 when discharge is occurring at the insulated portion 27. In the thirteenth embodiment, “error” is output instead of stopping the capillary electrophoresis apparatus 300.

In other words, in the thirteenth embodiment, the output processing unit 115 outputs “error” when discharge is occurring at the insulated portion 27, in other words, when determination in Step S406 is “No.” (S408B). Then, the operator responds to it. (S421) The thirteenth embodiment is different from the twelfth embodiment in the above-described respect, but is common to the twelfth embodiment in other respects. In. Thirteenth Embodiment, when it is determined that discharge is occurring at the insulated portion 27, the operator can find the occurrence of discharge at the insulated portion 27 by the output of “error”.

### Screen Example

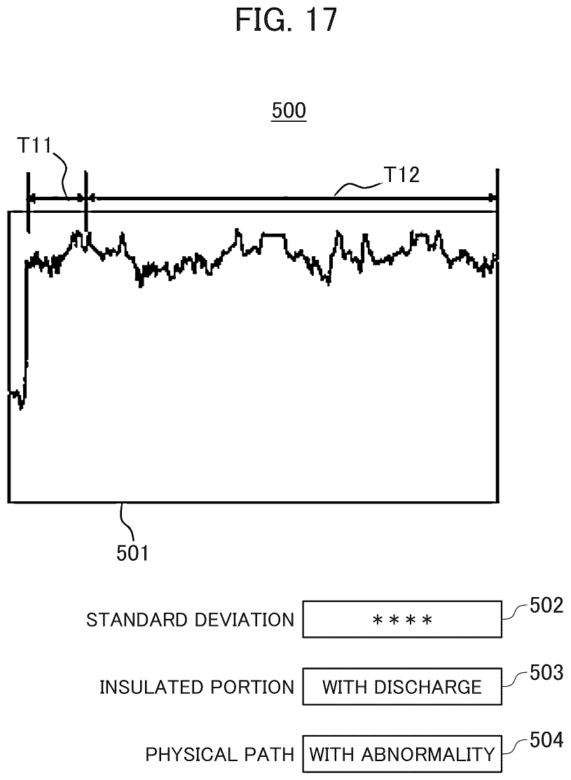

FIG. 17 is a view showing one example of an abnormality sensing screen 500.

As shown in FIG. 17, the abnormality sensing screen 500 has a source current value indication unit 501, a standard deviation indication unit 502, an insulated portion sensing result indication unit 503, and a physical path sensing result indication unit 504.

On the source current value indication unit 501, a source current value read in Step S101 and the like in FIG. 5 is indicated. On the source current value indication unit 501, Term T11 not used for the discharge sensing of the insulated portion 27 and Term T12 used therefor are preferably indicated as shown in FIG. 17.

On the standard deviation indication unit 502, the standard deviation calculated in Step S103 and the like in FIG. 5 is indicated. On the insulated portion sensing result indication unit 503, the sensing results of Step S108 and the like shown in FIG. 5 are indicated. This means that to the insulated portion sensing result indication unit 503, occurrence of discharge at the insulated portion 27 is output.

On the physical path sensing result indication unit 504, the sensing results of Step S204 and the like shown in FIG. 6 are indicated. This means that on the physical path sensing result indication unit 504, occurrence of abnormality in the physical path 26 is output.

The present invention is not limited to the above-described embodiments, and further includes various modifications. For example, the above-described embodiments have been described in detail in order to facilitate the understanding of the present invention, and the present invention is not necessarily limited to those including all of the described configurations. In addition, part of the configuration of one embodiment can be replaced with the configurations of other embodiments, and in addition, the configuration of the one embodiment can also be added with the configurations of other embodiments. In addition, part of the configuration of each of the embodiments can be subjected to addition, deletion, and replacement with respect to other configurations.

In each of the flowcharts of the present embodiment shown in FIGS. 5, 6, and 10 to 16, calculation of a standard deviation is followed by determination whether not the present current value is that immediately after a voltage change. The standard deviation may be calculated after determination that the present current value is not that immediately after a voltage change.

Some or all of the constitutions, functions, the processing unit 100, the current value acquisition unit 111 to the output processing unit 115, the recording device 13, and the like described above may be realized by a hardware, for example, by designing them with an integrated circuit. As shown in FIG. 2, with respect to each of the constitutions, functions, and the like described above, processers such as CPU may interpret and carry out the program that realizes their function and thereby realize by a software. Information such as programs, tables, and files for realizing each function can be stored not only in HD (Hard Disk) but also in the memory 11, a recording device such as SSD (Solid State Drive), or a recording medium such as IC (Integrated Circuit) card, SD (Secure Digital) card, or DVD (Digital Versatile Disc).

In each embodiment, a control line or information line necessary for description is indicated and not all the control lines or information lines are always indicated, which depends on the product. In practice, almost all the components may be connected to each other.

### LIST OF REFERENCE SIGNS

1: processing device (abnormality sensing device)
2: abnormality monitored device
3: capillary electrophoresis system
15: output device (output unit)
21: source current meter (first current meter)
22: return current meter (second current meter)
23: voltage source
24A: high-voltage power source
24: negative electrode terminal
25: positive electrode terminal
26: physical path (first path)
27: insulated portion (second path)
110: processing unit
111: current value acquisition unit
112: calculation unit
113: determination processing unit
114: control processing unit
115: output processing unit
300: capillary electrophoresis apparatus
301: sensing unit
302: light source
303: optical sensor
311: capillary array
312: capillary
312A: cathode edge
313: hollow electrode
331: load header
332: cathode buffer container
333: sample container
342: anode buffer container
342A: anode electrode
343a: first tube
343b: second tube
361: electrode
400: control computer
500: abnormality sensing screen
501: source current value indication unit
502: standard deviation indication unit
503: insulated portion sensing result indication unit
504: physical path sensing result indication unit
T11: Term
T12: term
Z: abnormality sensing system
S101: source current value reading (first current value reading step)
S103, S403: standard deviation calculation (standard deviation calculation step).
S104, S404: comparison between standard deviation and first threshold value (first determination step)
S106, S406: determination whether or not current value is that immediately after voltage change (exclusion step)
S107, S407: pending (exclusion step)
S408a: stopping of capillary electrophoresis apparatus (stop control processing step)
S408B: error output (error output step)
S201: return current value reading (second current value reading step)
S203: comparison between return current value and second threshold (second determination step)
S306: current value check (standard deviation calculation step to be performed before preliminary electrophoresis, aforesaid first determination step, second current value reading step, and aforesaid second determination step)
S307: current value check (standard deviation calculation step to be performed at the timing of preliminary electrophoresis, aforesaid first determination step, second current value reading step, and aforesaid second determination step)
S310: current value check (standard deviation calculation step to be performed during sample introduction, the aforesaid first determination step, second current value reading step, and aforesaid second determination step)
S313: current value check (standard deviation calculation step to be performed at the timing of the electrophoresis, aforesaid first determination step, second current value reading step, and the aforesaid second determination step)
S401: source current value reading (first current value reading step)

1. An abnormality sensing method comprising:
an abnormality sensing device that reads a first current value from a first current meter connected, between a first path through which a voltage applied by a voltage source conducted and the voltage source, series with the first path and the power source carries out
a standard deviation calculation step for calculating a standard deviation of the first current value; and
a first determination step for outputting the occurrence of discharge is at a second path; which is a path other than the first path and at the same time, is an insulated portion when the standard deviation is greater than a first threshold value which is a predetermined threshold value, wherein
the first path is provided in an abnormality monitored device that is a capillary electrophoresis device,
the first current meter is connected to a load header, and
the second path is between the load header and a cathode buffer container or between the load header and a buffer solution contained in the cathode buffer container.

2. The abnormality sensing method according to claim 1, wherein
the abnormality sensing device carries out a first current value reading step for reading the first current value at predetermined time intervals, and
the standard deviation calculation step calculates the standard deviation based on the first current value read at a predetermined sampling cycle.

3. The abnormality sensing method according to claim 1, wherein
the abnormality sensing device carries out an exclusion step for excluding, from an object of the discharge determination, the first current value read within a predetermined term after a change in a voltage to be applied by the voltage source.

4. The abnormality sensing method according to claim 1, wherein
the abnormality sensing device carries out
a stop control processing step for stopping an abnormality monitored device having the first path.

5. The abnormality sensing method according to claim 1, wherein
the abnormality sensing device carries out
an error output step for carrying out error output to an output unit when occurrence of the discharge is sensed.

6. The abnormality sensing method according to claim 5, wherein
the error output is output of an alarm.

717. The abnormality sensing method according to claim 1, wherein the abnormality sensing device carries out:
a second current value reading step for reading a second current value from a second current meter which is on a side opposite to the voltage source relative to the first path and is connected in series with the first path and the voltage source; and
a second determination step for calculating a variation value of the second current value and outputting occurrence of abnormality at the first path when the variation value is greater than a second threshold value, which is a predetermined value.

8. (canceled)

9. The abnormality sensing method according to claim 1, wherein
the standard deviation calculation step and the first determination step are carried out before the preliminary electrophoresis of the capillary electrophoresis apparatus.

10. The abnormality sensing method according to claim 9, wherein
the standard deviation calculation step and the first determination step are carried out at least one of the following timings: during the preliminary electrophoresis of the capillary electrophoresis apparatus, during sample introduction, and during electrophoresis.

11. The abnormality sensing method according to claim 1, wherein
a second current meter is connected to an anode electrode immersed in a buffer solution in an anode buffer container; and
the abnormality sensing device carries out:
a second current value reading step for reading a second current value from the second current meter; and
a second determination step for calculating a variation value of the second current value and, when the variation value is greater than a second threshold value which is a predetermined threshold value, outputting occurrence of abnormality at the first path.

12. The abnormality sensing method according to claim 11, wherein
the second current value reading step and the second determination step are carried out before the preliminary electrophoresis of the capillary electrophoresis apparatus.

13. The abnormality sensing method according to claim 11, wherein
the second current value reading step and the second determination step are carried out at least one of the following timings: during preliminary electrophoresis of the capillary electrophoresis apparatus; during sample introduction; and during electrophoresis.

14. An abnormality sensing device, comprising:
a calculation unit for calculating a standard deviation of a first current value read from a first current meter connected, between a first path through which a voltage applied by a voltage source flows and the voltage source, in series with the first path and the voltage source: and
a determination processing unit for outputting occurrence of discharge at a second path, which is a path other than the first path, and at the same time is an insulated portion when the standard deviation is greater than a first threshold value, which is a predetermined threshold value wherein
the first path is provided in an abnormality monitored device that is a capillary electrophoresis device,
the first current meter is connected to a load header, and
the second path is between the load header and a cathode buffer container or between the load header and a buffer solution contained in the cathode buffer container.
